(19) United States
(12) Patent Application Publication
(10) Pub. No.: US 2026/0142530 A1
(43) Pub. Date: May 21, 2026

(54) AXIAL FLOW MACHINE, IN PARTICULAR FOR A MOTOR VEHICLE

(71) Applicant: MERCEDES-BENZ GROUP AG, Stuttgart (DE)

(72) Inventors: Wolfgang REHM, Ulm (DE); Christopher BECK, Ulm (DE); Robert LEHMANN, Stuttgart (DE); Uli BENDRICH, Weissach im Tal (DE); Mike FUCHSLOCHER, Stuttgart (DE)

(21) Appl. No.: 19/102,051

(22) PCT Filed: Aug. 3, 2023
(86) PCT No.: PCT/EP2023/071621

§ 371 Date: Feb. 7, 2025

(30) Foreign Application Priority Data
Aug. 8, 2022 (DE) 10 2022 002 863.8

(51) Int. Cl. H02K 9/19; H02K 1/27; H02K 5/20

(52) U.S. Cl. CPC H02K 9/19; H02K 1/27; H02K 5/203

(57) ABSTRACT

An axial flow machine includes a rotor having a rotor carrier, magnets held on the rotor carrier, and cooling channels extending inside the rotor carrier. The cooling channels can each be flowed through by cooling air for cooling the rotor and have a respective inlet via which the cooling air can be introduced into the respective cooling channel and an outlet via which the cooling air can be discharged from the respective cooling channel. A valve device, assigned to the inlets, adjusts a flow cross-section of the respective inlet through which the cooling air can flow.

### BACKGROUND AND SUMMARY OF THE INVENTION

Exemplary embodiments of the invention relate to an axial flow machine, in particular for a motor vehicle.

Such an axial flow machine is already taken as known for example, from WO 2015/019107 A2, WO 2016/185173 A1, EP 2 835 895 A2 and EP 1 559 604 A1. The axial flow machine has a rotor having a rotor carrier, magnets held on the rotor carrier and cooling channels extending inside the rotor carrier. The cooling channels can each be flowed through by cooling air for cooling the rotor. The respective cooling channel has a respective inlet via which the cooling air can be introduced into the respective cooling channel. Furthermore, the respective cooling channel has at least one respective outlet via which the cooling air can be discharged.

Exemplary embodiments of the present invention are directed to further developing an axial flow machine of the above-mentioned type in such a way that particularly advantageous and customized cooling of the rotor can be realized.

In order to further develop an axial flow machine of the type in such a way that particularly advantageous and customized cooling of the rotor can be realized, it is provided according to the invention that the axial flow machine has a valve device assigned to the inlets and by means of which a flow cross-section of the respective inlets through which the cooling air can flow can be adjusted, i.e., changed. In particular, the valve device can be moved, in particular rotated, relative to the rotor between a closed position closing the inlets, and thus reducing the respective flow cross-section to zero, and at least one open position releasing the inlets, so that in the open position the flow cross-section is greater than zero. Thus, in the open position, cooling air can flow through the respective inlet and thus flow into the respective cooling channel via the respective inlet. In the closed position, cooling air cannot flow through the respective inlet and thus cannot flow into the respective cooling channel via the respective inlet.

The invention is based in particular on the following findings: Heat is produced in electric engines due to electromagnetic losses. This heat is to be discharged in order to avoid a power reduction or damage to or destruction of the machine. A maximum temperature is not to be exceed especially in the case of axial flow machines (AFM), in order to not undesirably impair the strength of adhesive bonds between the magnets, designed for example as permanent magnets, and the rotor carrier. For this purpose, natural convection is not sufficient at high powers. Liquid-cooled rotors are very complex. External fins on the rotor would lead to high ventilation losses. Therefore, according to the invention, the valve device is provided which, for example, can be opened and closed automatically and/or temperature-dependently and can adjust the flow cross-sections. Since the cooling channels extend inside the rotor carrier, the cooling channels are internal cooling channels via which heat can be discharged particularly advantageously from the rotor. In the operating states in which cooling the rotor via the cooling channels is not required or desired, the valve device is located, for example, in the closed position. As a result, a particularly low-loss operation can be realized. In operating states in which cooling the rotor via the cooling channels is advantageous or desired, the valve device can be located in the open position, whereby heat can be effectively and efficiently discharged from and in particular by the rotor.

The valve device is, for example, a disc, in particular a shutter pinhole, which, for example, can be rotated around a rotational axis around which the rotor of the axial flow machine relative to a stator of the axial flow machine. For example, an actuator is assigned to the valve device, by means of which the valve device can be moved, in particular rotated, relative to the rotor. The actuator can be automatic and/or temperature-controlled. For example, the actuator can be designed as a bimetal strip or be formed from a shape memory alloy. Furthermore, it is conceivable that the actuator is an electrically operated actuator, in particular an electric motor, so that for example the valve device can be moved relative to the rotor by means of the actuator using electric energy. The invention enables customized cooling and thus increased performance and increased reliability of the axial flow machine in comparison to conventional solutions. In particular, a particularly efficient operation of the axial flow machine can be realized by a loss reduction. The previous and following embodiments can be easily transferred to radial flow machines, so that the invention can also be used for radial flow machines.

Further advantages, features and details of the invention result from the following description of preferred exemplary embodiments and with reference to the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The drawing shows in:

FIG. 1 a schematic front view in part of a first embodiment of a rotor of an axial flow machine;

FIG. 2 a schematic longitudinal section view in part of the rotor of the axial flow machine according to FIG. 1;

FIG. 3 a schematic longitudinal section view in part of an upper half of a rotor of an axial flow machine in a second embodiment and

FIG. 4 a schematic longitudinal section view in part of an upper half of a third embodiment of a rotor of an axial flow machine.

In the figures, identical or functionally identical elements are provided with the same reference signs.

### DETAILED DESCRIPTION

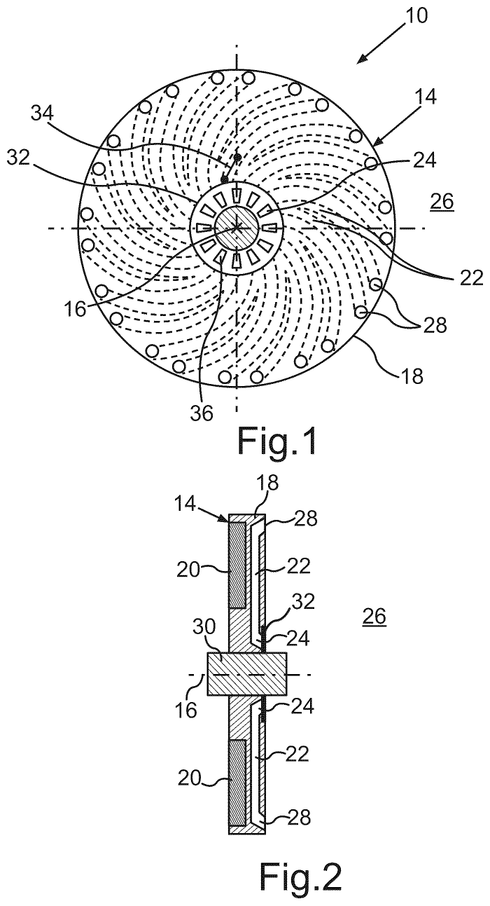

FIG. 1 shows a partial schematic front view of a rotor 14 of an electric engine, designed as an axial flow machine 10, in particular for a motor vehicle. This means, for example, that the axial flow machine 10 is designed to electrically drive the motor vehicle, in particular purely electrically. FIGS. 1 and 2 show a first embodiment of the rotor 14 of the axial flow machine 10. As can be seen in combination with FIG. 4, the axial flow machine 10 has a stator 12 and a rotor 14 drivable by the stator 12 and therefore can be rotated around a rotational axis 16 relative to the stator 12. Here, FIG. 4 only shows a schematic section of such an axial flow machine 10, which has at least one stator 12 and at least one rotor 14, so that the representation does not result in any restriction to the type of the axial flow machine 10 and is to be seen purely as an example.

As can be seen from FIGS. 1 and 2, the rotor 14 has a rotor carrier 18 and magnets 20. For example, the magnets 20 are designed separately from the rotor carrier 18 and are held on the rotor carrier 18, in particular by the respective magnet 20 being connected to the rotor carrier 18 by a respective adhesive connection. In particular, the respective magnet 20 is a respective permanent magnet. Furthermore, the rotor 14 has cooling channels 22 extending inside the rotor carrier 18. Since the cooling channels 22 extend inside the rotor carrier 18, respective partial regions of the cooling channels 22 cannot be seen in FIG. 1, with these partial regions being illustrated in FIG. 1 by dashed lines. The respective cooling channel 22 can be flowed through by cooling air, in particular in the radial direction of the rotor 14 from the inside to the outside. For this purpose, the respective cooling channel 22, also referred to as a cooling air channel, has a respective inlet 24 via which the air, in particular from the surroundings 26 of the rotor 14, can be introduced into the respective cooling channel 22. Furthermore, the respective cooling channel 22 has a respective outlet 28 via which the cooling air flowing though the respective cooling channel 22 can be discharged from the respective cooling channel 22 and, for example, can be guided into the surroundings 26. It can be seen that the respective outlets 28 are placed further out in the radial direction of the rotor 14 than the respective inlets 24, which are also referred to as intakes. The respective inlet 24, also referred to as an intake, extends parallel to the axial direction or oblique to the axial direction of the rotor 14 and thus to the axial flow machine 10.

It can also be seen from FIG. 1 that the first embodiment divides the cooling channels 22 in the rotor carrier 18, so that each inlet 24 having a beginning of a cooling channel 22 is then assigned and fluidically connected to several outlets 28 with a respective cooling channel 22 and thus several cooling channels 22. For example, in the first embodiment, the one inlet 24 with the one cooling channel 22, which then splits into two cooling channels 22, is also assigned two outlets 28 and fluidically connected thereto. Depending on the size and design of a rotor, the branching ratio of the cooling channels can be determined here, since the cooling is to take place over the complete circumference, which increases outwardly with the radius, so that here the cooling channels 22 cannot be arbitrarily widened due to stability reasons and thus branch out in order to also cover the outwardly increasing circumference.

It can be seen from FIG. 2 that the rotor 14 has a rotor shaft 30, also simply referred to as a shaft. For example, the rotor carrier 18 is connected to the rotor shaft 30 for conjoint rotation. In this case, it is conceivable that the rotor carrier 18 is separate from the rotor shaft 30 and is connected to the rotor shaft 30 for conjoint rotation.

In order to be able to realize particularly advantageous and customized cooling of the rotor 14, the rotor 14 of the axial flow machine 10, as can be seen particularly well from FIG. 1, has a valve device 32 assigned to the inlets 24 and common to the inlets 24 and by means of which a respective flow cross-section of the respective inlet 24 through which cooling air can flow can be flowed through. The valve device 32 can be rotated around the rotational axis 16 relative to the rotor 14, whereby the, in particular all, flow cross-sections of the, in particular all, inlets 24 can be adjusted, in particular simultaneously. In particular, the valve device 32 can be twisted around the rotational axis 16 relative to the rotor 14 between a closed position and at least one open position, and thus can be moved. In the closed position, the inlets 24 are fluidically blocked by means of the valve device 32, so that the flow cross-sections are reduced to zero. Thus, cooling air cannot flow through the inlets 24 from the surroundings 26. In the open position, the valve device 32 releases the inlets 24, so that in the open position, the flow cross-sections are greater than zero. Thus, air, as cooling air, can flow through the inlets 24 from the surroundings 26 and thus flow into the cooling channels 22. In particular, the valve device 32 can be rotated into several open positions that are different from each other, in which the flow cross-sections each have a value greater than zero.

It can be seen from FIG. 1 that an actuator 34 is assigned to the valve device 32, by means of which the valve device 32 can be rotated around the rotational axis 16 relative to the rotor 14 in order to thereby adjust the flow cross-sections. The actuator 34 is a bimetal strip, for example. Furthermore, it is conceivable that the actuator 34 is formed from a shape memory alloy. Thus, the actuator 34 can be deformed non-destructively by temperature changes of the rotor 14, the temperature changes of which coincide with the temperature changes of the actuator 34, wherein the valve device 32 can be rotated around the rotational axis 16 relative to the rotor 14 by deforming the actuator 34. Therefore, the flow cross-sections are adjusted, i.e., changed, automatically and depending on the temperature changes of the rotor 14, so that particularly simple, cost-effective and customized cooling of the rotor 14 can be achieved. Overall, it is conceivable that the valve device 32 functions as a valve, by means of which the flow cross-sections and thus a respective amount of cooling air that flows through the flow cross-sections can be adjusted.

In the first embodiment, the valve device 32 is designed as a pinhole or as a type of pinhole. For each inlet 24, the valve device 32 has at least or exactly one through opening 36. In the open position, the respective inlet 24 is overlapped by a respective one of the through openings 36, whereby the respective inlet 24 is released. In the closed position, the inlets 24 are closed by means of respective wall portions of the valve device 32 that are adjacent to the through openings 36, in that the inlets 24 are covered with respect to the surroundings 26 by the wall portions in the axial direction of the axial flow machine 10.

In the first embodiment, the respective inlet 24 extends oblique to the axial direction of the rotor 14, so that the cooling air can flow through respective inlet 24 along a first flow direction, wherein the first flow direction thus also extends oblique to the axial direction of the rotor 14. In the first embodiment, the respective outlet 28 similarly extends oblique to the axial direction of the rotor 14, so that the cooling air can flow through the respective outlet 28 along a respective second flow direction. The second flow direction thus also extends oblique to the axial direction of the rotor 14, wherein the second flow direction has a different diagonal with respect to the axial direction of the rotor 14 than the first flow direction, in particular the axial component of the two diagonals of the flow directions is reversed and in particular, for example, the radial component of the two diagonals of the flow directions is the same.

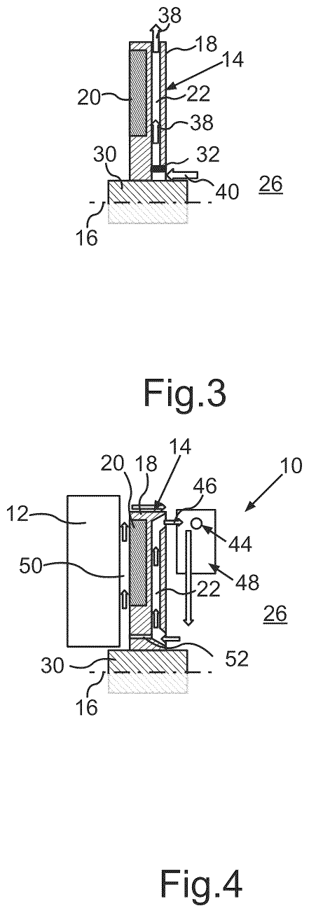

Furthermore, it is conceivable that at least one of the two respective flow directions extends parallel to the axial direction of the rotor 14, as is represented in FIG. 3 in a second embodiment with the inlet 24.

FIG. 3 shows in a section, a second embodiment of the rotor 14, in which the respective inlet 24 extends in the axial direction of the rotor 14 and the respective outlet 28 extends in the radial direction of the rotor 14, so that the respective first flow direction extends in the axial direction of the rotor 14, illustrated by the arrow 40, and the respective second flow direction extends in the radial direction of the rotor 14, illustrated by the arrow 38.

In the second embodiment of the rotor 14 in FIG. 3, the valve device 32 is designed, for example, as a cylindrical thin-walled tube piece with radial openings.

Finally, FIG. 4 shows a section of a third embodiment of a rotor 14 of an axial flow machine 10. In the third embodiment, at least one of the outlets 28 is assigned a heat pipe 44, which, as is illustrated by an arrow 46, can be flowed through by the cooling air flowing through at least one outlet 28 and thus flowing out of the associated cooling channel 22 via the at least one outlet. The heat pipe 44 is one possible embodiment of a heat sink, which can absorb heat from or out of the cooling air flowing through the at least one outlet 28 and, for example, can transmit it to another, in particular liquid cooling medium or working medium, in particular via cooling fins 48, with which the heat pipe 44 can be provided. The other coolant or working medium can, for example, be water, i.e., cooling water, or also oil, so that water or oil cooling is possible. For example, the heat pipe 44 and, for example, the cooling fins 48 as well are arranged in a circuit.

In a further advantageous embodiment, the rotor 14 can be cooled not just by the cooling channel 22, but also by an air flow through the air gap 50 between the stator 12 and the rotor 14, which is formed in the shape of a disc in an axial flow machine. The air gap 50 can also be used as a further cooling channel in its disc shape, whereby air gap cooling can be or is realized. The air flow through the air gap 50 as a cooling channel is guided on the outer circumference of the rotor 14 back onto a rotor back panel of the rotor 14, wherein the cooling air can be guided in the circuit onto the rotor back panel. In the process, the heat can be directly removed in the mentioned circuit inside a housing of the axial flow machine 10 through the heat pipe 44 and if necessary the cooling fins 48 and as a whole guided outwards, i.e., to the surroundings of the housing, in particular of the axial flow machine 10, and there can be dissipated to air, oil or water, i.e., to another or the aforementioned other coolant, in a heat exchanger.

For example, the rotor carrier 18 has at least one connecting duct 52 designed as a bore, for example, via which the air gap 50 is connected fluidically to the cooling channel 22. Thus, for example, the cooling air can be divided downstream of the heat pipe 44 into a first sub-stream and into a second sub-stream. The first sub-stream flows through the cooling channel 22 and the second sub-stream flows through the connecting duct 52 and thus through the air gap 50. The sub-streams are combined upstream of the heat pipe 44 to form a total stream, which is then divided downstream of the heat pipe 44 into the first sub-stream and the second sub-stream. Thus, at least one part of the cooling air can be supplied to the air gap 50 between the stator 12 and the rotor 14 through the connecting ducts 52 designed for example as connecting bores, whereby the air gap cooling is realized. This air gap cooling is supported by a suction effect of an escaping skin cooling air flow, in particular on a front side of the rotor 14 facing the heat pipe 44.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

List of reference signs

| | |
|---|---|
| 10 | axial flow machine |
| 12 | stator |
| 14 | rotor |
| 16 | rotational axis |
| 18 | rotor carrier |
| 20 | magnet |
| 22 | cooling channel |
| 24 | inlet |
| 26 | surroundings |
| 28 | outlet |
| 30 | rotor shaft |
| 32 | valve device |
| 34 | actuator |
| 36 | through opening |
| 38 | arrow |
| 40 | arrow |
| 42 | arrow |
| 44 | heat pipe |
| 46 | arrow |
| 48 | cooling fins |
| 50 | air gap |
| 52 | connecting duct |

1-5. (canceled)

6. An axial flow machine comprising:
a rotor having a rotor carrier;
magnets held on the rotor carrier;
cooling channels extending inside the rotor carrier, wherein the cooling channels are configured so that each can be flowed through by cooling air to cool the rotor, wherein each of the cooling channels has a respective inlet via which the cooling air is introducible into the respective cooling channel and an outlet via which the cooling air is dischargeable from the respective cooling channel; and
a valve device, assigned to the inlets, configured to adjust a flow cross-section of the respective inlet through which the cooling air is flowable.

7. The axial flow machine of claim 6, wherein the valve device is moveable relative to the rotor between a closed position closing the inlets and at least one open position opening the inlets.

8. The axial flow machine of claim 6, wherein the valve device is rotatable relative to the rotor around a rotational axis to adjust the flow cross-sections, and wherein the rotational axis is around which the rotor is rotatable relative to a stator of the axial flow machine.

9. The axial flow machine of claim 6, wherein the respective outlet extends in a radial direction or in an axial direction of the axial flow machine.

10. The axial flow machine of claim 6, wherein at least one of the outlets is assigned a heat pipe against which the cooling air flowing through the at least one outlet can be flow, at least in a partial area.

11. The axial flow machine of claim 6, wherein the valve device includes an actuator configured to rotate the valve device based on a temperature of the rotor.

12. The axial flow machine of claim 11, wherein the actuator is a bimetal strip.

13. The axial flow machine of claim 11, wherein the actuator is a shape memory alloy.
